(19) United States
(12) Patent Application Publication
(10) Pub. No.: US 2023/0096182 A1
(43) Pub. Date: Mar. 30, 2023

(54) SYSTEMS AND METHODS FOR PREDICTING AND IDENTIFYING MALICIOUS EVENTS USING EVENT SEQUENCES FOR ENHANCED NETWORK AND DATA SECURITY

(71) Applicant: BANK OF AMERICA CORPORATION, Charlotte, NC (US)

(72) Inventors: Tomas M. Castrejon, III, Fort Mill, SC (US); Christopher Daniel Birch, Tega Cay, SC (US); Christopher Stephen Littrell, Dallas, TX (US)

(73) Assignee: BANK OF AMERICA CORPORATION, Charlotte, NC (US)

(21) Appl. No.: 17/490,291

(22) Filed: Sep. 30, 2021

(51) Int. Cl. G06F 21/55; G06F 21/54; G06F 21/57; G06N 20/00

(52) U.S. Cl. CPC G06F 21/554; G06F 21/54; G06F 21/577; G06N 20/00

(57) ABSTRACT

Systems, methods, and computer program products are provided for identifying a potential malicious event. The method includes receiving a plurality of program actions comprising at least a first program action and a second program action. The first program action is initiated before the second program action. The method also includes comparing the plurality of program actions with at least one known malicious event pattern of actions. The at least one malicious event pattern of actions includes a sequence of program actions in a known malicious event. The method further includes determining a potential malicious event is occurring based on the comparison of the plurality of program actions with at least one known malicious event pattern of actions. The method still further includes determining a preventative response based on the potential malicious event.

### TECHNOLOGICAL FIELD

An example embodiment relates generally to identifying malicious events, and more particularly, to identifying and preventing malicious events using event sequences for enhanced network and data security.

### BACKGROUND

Malicious events, such as ransomware, are often detected too late since damage to a system can start as soon as the malicious event begins (e.g., as soon as the ransomware gains access to a network or system). Therefore, it is paramount that such attacks are identified before the malicious event has taken hold. For example, in a ransomware attack, the file encryption process can begin as soon as the ransomware has infected a computer and continue to multiple devices on a network in a short time. As such, the earlier an attack is detected, the less files and/or devices that may be affected. There exists a need for a system that can improve the detection and prevention of malicious events.

### BRIEF SUMMARY

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows.

In an example embodiment, a system for identifying a potential malicious event is provided. The system includes at least one non-transitory storage device and at least one processing device coupled to the at least one non-transitory storage device. The at least one processing device is configured to receive a plurality of program actions including at least a first program action and a second program action. The first program action is initiated before the second program action. The at least one processing device is also configured to compare the plurality of program actions with at least one known malicious event pattern of actions The at least one malicious event pattern of actions includes a sequence of program actions in a known malicious event. The at least one processing device is further configured to determine an occurrence of a potential malicious event based on the comparison of the plurality of program actions with at least one known malicious event pattern of actions. The at least one processing device is still further configured to determine a preventative response based on the potential malicious event.

In some embodiments, the at least one processing device is further configured to cause an execution of the preventative response. In some embodiments, the preventative response is carried out during the potential malicious event. In some embodiments, the at least one processing device is further configured to update a malicious event engine using machine learning based on the determination of the potential malicious event.

In some embodiments, the preventative response is determined based on a type of potential malicious event determined. In some embodiments, the preventative response includes a notification of the potential malicious event. In some embodiments, the preventative response includes locking out a user associated with at least one of the plurality of program actions.

In another example embodiment, a computer program product for identifying a potential malicious event is provided. The computer program product includes at least one non-transitory computer-readable medium having computer-readable program code portions embodied therein The computer-readable program code portions include an executable portion configured to receive a plurality of program actions including at least a first program action and a second program action. The first program action is initiated before the second program action. The computer-readable program code portions also include an executable portion configured to compare the plurality of program actions with at least one known malicious event pattern of actions. The at least one malicious event pattern of actions includes a sequence of program actions in a known malicious event. The computer-readable program code portions further include an executable portion configured to determine an occurrence of a potential malicious event based on the comparison of the plurality of program actions with at least one known malicious event pattern of actions. The computer-readable program code portions still further include an executable portion configured to determine a preventative response based on the potential malicious event.

In some embodiments, the computer-readable program code portions further include an executable portion configured to cause an execution of the preventative response. In some embodiments, the preventative response is carried out during the potential malicious event. In some embodiments, the computer-readable program code portions further include an executable portion configured to update a malicious event engine using machine learning based on the determination of the potential malicious event.

In some embodiments, the preventative response is determined based on a type of potential malicious event determined. In some embodiments, the preventative response includes a notification of the potential malicious event. In some embodiments, the preventative response includes locking out a user associated with at least one of the plurality of program actions.

In still another example embodiment, a computer-implemented method for identifying a potential malicious event is provided. The method includes receiving a plurality of program actions including at least a first program action and a second program action. The first program action is initiated before the second program action. The method also includes comparing the plurality of program actions with at least one known malicious event pattern of actions. The at least one malicious event pattern of actions includes a sequence of program actions in a known malicious event. The method further includes determining an occurrence of a potential malicious event based on the comparison of the plurality of program actions with at least one known malicious event pattern of actions. The method still further includes determining a preventative response based on the potential malicious event.

In some embodiments, the method includes causing an execution of the preventative response. In some embodiments, the preventative response is carried out during the potential malicious event. In some embodiments, the method includes updating a malicious event engine using machine learning based on the determination of the potential malicious event.

In some embodiments, the preventative response is determined based on a type of potential malicious event determined. In some embodiments, the preventative response includes locking out a user associated with at least one of the plurality of program actions.

Embodiments of the present disclosure address the above needs and/or achieve other advantages by providing apparatuses (e.g., a system, computer program product and/or other devices) and methods for dynamically generating optimized data queries to improve hardware efficiency and utilization. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the disclosure in general terms, reference will now be made the accompanying drawings, wherein:

FIG. 1 provides a block diagram illustrating a system environment for identifying potential malicious events, in accordance with embodiments of the present disclosure;

FIG. 2 provides a block diagram illustrating the entity system 200 of FIG. 1, in accordance with embodiments of the present disclosure;

FIG. 3 provides a block diagram illustrating a malicious event determination device 300 of FIG. 1, in accordance with embodiments of the present disclosure;

FIG. 4 provides a block diagram illustrating the computing device system 400 of FIG. 1, in accordance with embodiments of the present disclosure; and

FIG. 5 provides a flowchart illustrating a method of identifying a potential malicious event in accordance with embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources, including, but not limited to, one or more entity systems, one or more entity databases, one or more applications, one or more servers, or the like to perform one or more organization activities associated with the entity. In some embodiments, an entity may be any organization that develops, maintains, utilizes, and/or controls one or more applications and/or databases. Applications as described herein may be any software applications configured to perform one or more operations of the entity. Databases as described herein may be any datastores that store data associated with organizational activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the financial institution may allow a customer to establish an account with the financial institution. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications provided by the entity and/or the system of the present disclosure. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making prediction about a dataset. Machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification.

Malicious attacks, specifically ransomware attacks, are an ever-increasing problem in the internet-connected world in which personal data is provided, stored, and transmitted by many different entities. The increase in potentially accessible personal data has led to an increase in attempts at malicious attacks, and due to increased security, a higher level of sophistication in such malicious attacks. Malicious attacks, such as ransomware, often get access to a network, and once accessed, deploy programs allowing data on such networks to be accessed and/or manipulated.

Therefore, while it is preferred to completely prevent malicious events, it is also beneficial to stop existing attacks as early as possible in order to mitigate potential damage. Various embodiments of the present disclosure analyze patterns of program actions to identify a potential malicious event and then perform one or more preventative responses based on the potential malicious event. The early identification of potential malicious events allows for such events to be stopped before large amounts of data is accessed. For example, in a ransomware attack, embodiments of the present disclosure may stop said ransomware from encrypting one or more files in the network.

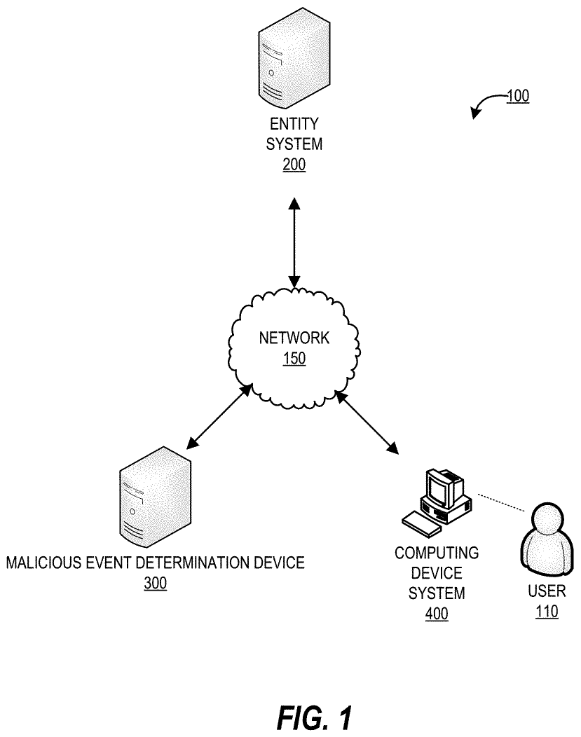

FIG. 1 provides a block diagram illustrating a system environment 100 for identifying and preventing malicious events using event sequences for enhanced network and data security, in accordance with an embodiment of the present disclosure. As illustrated in FIG. 1, the environment 100 includes a malicious event determination device 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees (e.g., application developers, database administrators, application owners, application end users, business analysts, finance agents, or the like) of an entity associated with the entity system 200.

The entity system(s) 200 may be any system owned or otherwise controlled by an entity to support or perform one or more process steps described herein. In some embodiments, the entity is a financial institution. In some embodiments, the entity may be a non-financial institution. In some embodiments, the entity may be any organization that utilizes one or more entity resources to perform one or more organizational activities.

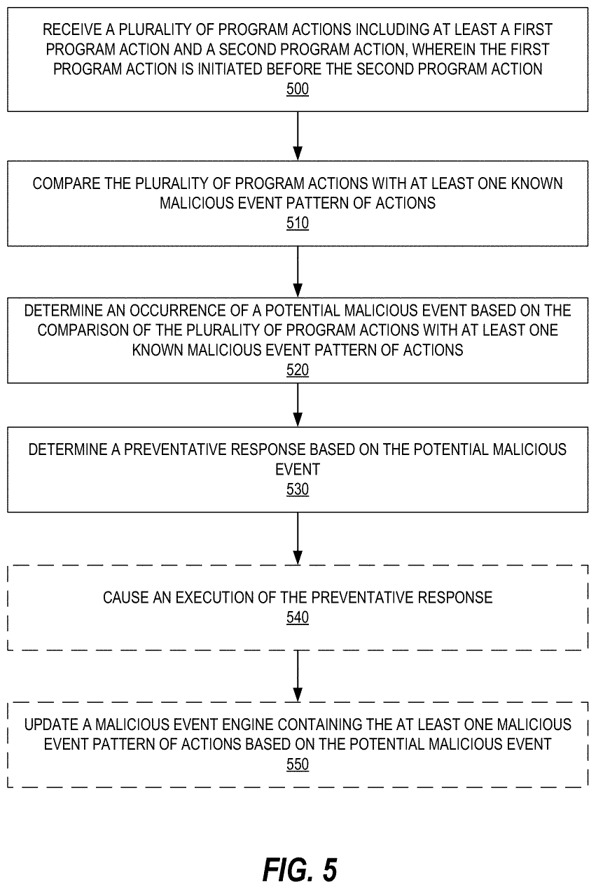

The malicious event determination device 300 is a system of the present disclosure for performing one or more process steps described herein. In some embodiments, the malicious event determination device 300 may be an independent system. In some embodiments, the malicious event determination device 300 may be a part of the entity system 200. For example, the method of FIG. 5 may be carried out by the entity system 200, the malicious event determination device 300, the computing device system 400, and/or a combination thereof.

The malicious event determination device 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the malicious event determination device 300 is configured to communicate information or instructions with the entity system 200, and/or the computing device system 400 across the network 150. While the entity system 200, the malicious event determination device 300, and the computing device system 400 are illustrated as separate components communicating via network 150, one or more of the components discussed here may be carried out via the same system (e.g., a single system may include the entity system 200 and the malicious event determination device 300).

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the malicious event determination device 300, and/or entity system 200 across the network 150.

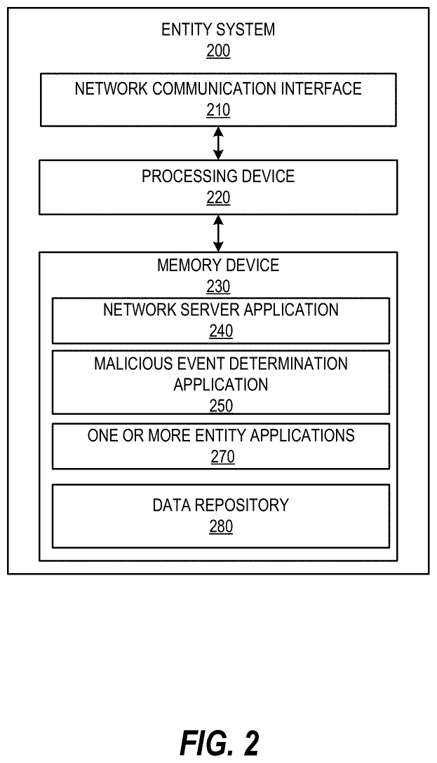

FIG. 2 provides a block diagram illustrating the entity system 200, in greater detail, in accordance with embodiments of the disclosure. As illustrated in FIG. 2, in one embodiment, the entity system 200 includes one or more processing devices 220 operatively coupled to a network communication interface 210 and a memory device 230. In certain embodiments, the entity system 200 is operated by a first entity, such as a financial institution. In some embodiments, the entity system 200 may be a multi-tenant cluster storage system.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a malicious event determination application 250, one or more entity applications 270, and a data repository 280 comprising data accessed, retrieved, and/or computed by the entity system 200. The one or more entity applications 270 may be any applications developed, supported, maintained, utilized, and/or controlled by the entity. The computer-executable program code of the network server application 240, the malicious event determination application 250, the one or more entity application 270 to perform certain logic, data-extraction, and data-storing functions of the entity system 200 described herein, as well as communication functions of the entity system 200.

The network server application 240, the malicious event determination application 250, and the one or more entity applications 270 are configured to store data in the data repository 280 or to use the data stored in the data repository 280 when communicating through the network communication interface 210 with the malicious event determination device 300, and/or the computing device system 400 to perform one or more process steps described herein. In some embodiments, the entity system 200 may receive instructions from the malicious event determination device 300 via the malicious event determination application 250 to perform certain operations. The malicious event determination application 250 may be provided by the malicious event determination device 300. The one or more entity applications 270 may be any of the applications used, created, modified, facilitated, and/or managed by the entity system 200.

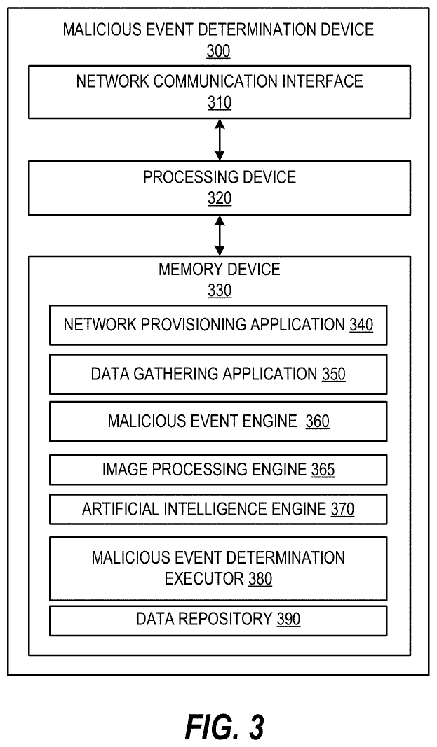

FIG. 3 provides a block diagram illustrating the malicious event determination device 300 in greater detail, in accordance with various embodiments. As illustrated in FIG. 3, in one embodiment, the malicious event determination device 300 includes one or more processing devices 320 operatively coupled to a network communication interface 310 and a memory device 330. In certain embodiments, the malicious event determination device 300 is operated by an entity, such as a financial institution. In some embodiments, the malicious event determination device 300 is owned or operated by the entity of the entity system 200. In some embodiments, the malicious event determination device 300 may be an independent system. In alternate embodiments, the malicious event determination device 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the malicious event determination device 300 described herein. For example, in one embodiment of the malicious event determination device 300, the memory device 330 includes, but is not limited to, a network provisioning application 340, a data gathering application 350, a malicious event engine 360, an image processing engine 365, an artificial intelligence engine 370, a malicious event determination executor 380, and a data repository 390 comprising any data processed or accessed by one or more applications in the memory device 330. The computer-executable program code of the network provisioning application 340, the data gathering application 350, the malicious event engine 360, the image processing engine 365, the artificial intelligence engine 370, and the malicious event determination executor 380 may instruct the processing device 320 to perform certain logic, data-processing, and data-storing functions of the malicious event determination device 300 described herein, as well as communication functions of the malicious event determination device 300.

The network provisioning application 340, the data gathering application 350, the malicious event engine 360, the image processing engine 365, the artificial intelligence engine 370, and the malicious event determination executor 380 are configured to invoke or use the data in the data repository 390 when communicating through the network communication interface 310 with the entity system 200, and/or the computing device system 400. In some embodiments, the network provisioning application 340, the data gathering application 350, the malicious event engine 360, the image processing engine 365, the artificial intelligence engine 370, and the malicious event determination executor 380 may store the data extracted or received from the entity system 200, and the computing device system 400 in the data repository 390. In some embodiments, the network provisioning application 340, the data gathering application 350, the malicious event engine 360, the image processing engine 365, the artificial intelligence engine 370, and the malicious event determination executor 380 may be a part of a single application.

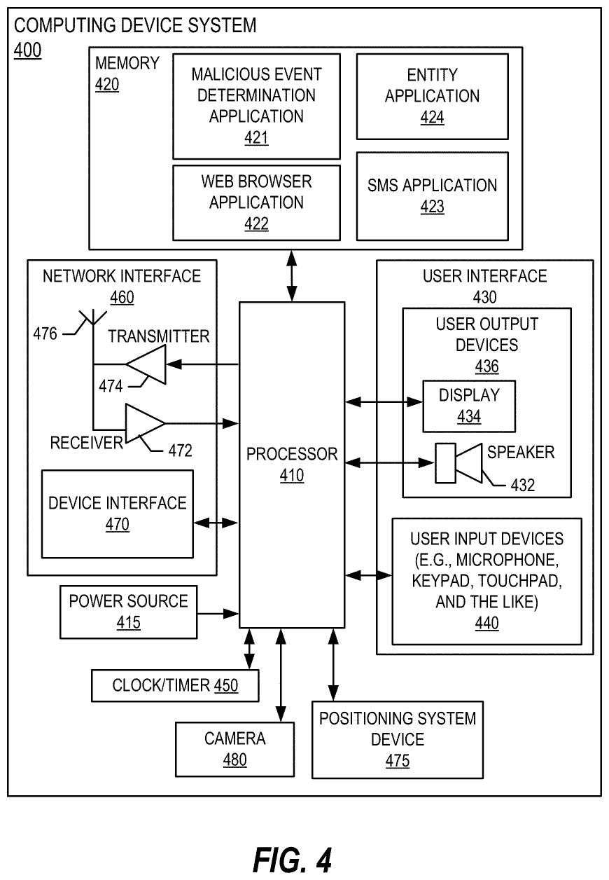

FIG. 4 provides a block diagram illustrating a computing device system 400 of FIG. 1 in more detail, in accordance with various embodiments. However, it should be understood that a mobile telephone is merely illustrative of one type of computing device system 400 that may benefit from, employ, or otherwise be involved with embodiments of the present disclosure and, therefore, should not be taken to limit the scope of embodiments of the present disclosure. Other types of computing devices may include portable digital assistants (PDAs), pagers, mobile televisions, electronic media devices, desktop computers, workstations, laptop computers, cameras, video recorders, audio/video player, radio, GPS devices, wearable devices, Internet-of-things devices, augmented reality devices, virtual reality devices, automated teller machine (ATM) devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a malicious event determination application 421, entity application 424. These applications also typically instructions to a graphical user interface (GUI) on the display 430 that allows the user 110 to interact with the entity system 200, the malicious event determination device 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the malicious event determination application 421 provided by the malicious event determination device 300 allows the user 110 to access the malicious event determination device 300. In some embodiments, the entity application 424 provided by the entity system 200 and the malicious event determination application 421 allow the user 110 to access the functionalities provided by the malicious event determination device 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

Referring now to FIG. 5, a method of identifying a potential malicious event is provided. The method may be carried out by a system discussed herein (e.g., the entity system 200, the malicious event determination device 300, and/or the computing device system 400). An example system may include at least one non-transitory storage device and at least one processing device coupled to the at least one non-transitory storage device. In such an embodiment, the at least one processing device is configured to carry out the method discussed herein.

The term “malicious event” refers to one or more actions that are unauthorized and/or have unauthorized results based on said actions. A malicious event may be a malware attack (e.g., a ransomware attack). Additionally, a malicious event may be any other type of hack by a third party. Such a malicious event may be carried out with the intent to perform a malicious attack.

Referring now to Block 500 of FIG. 5, the method may include receiving a plurality of program actions including at least a first program action and a second program action. The first program action is initiated before the second program action. The program actions may be related (e.g., the first program action may trigger the second program action) and/or the program actions may be independent (e.g., the program actions are not caused by one another). The plurality of program actions may include additional program actions beyond the first program action and the second program action (e.g., a third program action, a fourth program action, etc.).

In various embodiments, a program action is any action or step carried out by a device during operation. The program action may be initiated, at least partially, by a user associated with the device (e.g., a user selects an application to be opened by the device). Additionally or alternatively, a program action may be carried out in the background (e.g., a malicious file may be downloaded by a user and then said malicious file allows unauthorized access to a given device and/or network). In an example, a first program action may be opening and/or using a word processing application, that triggers a second action, such as triggering a task automation and configuration management framework (e.g., PowerShell). Additional program actions may occur, such as communication with a third-party system (e.g., a bad actor). As such, the plurality of program actions has a sequence or pattern, that is then compared to at least one known malicious event pattern of actions as discussed in reference to Block 510.

In some embodiments, the given program actions may be received in or near real-time (e.g., as the action is carried out, the system receives information relating to said program action). Additionally or alternatively, two or more program actions may be received at the same time. Some or all of the plurality of program actions may be recorded in a log, that is then analyzed by the systems discussed herein. A log may record one or more program actions and said log can be stored in a storage device discussed herein. Additionally, such a log may be compiled by a third-party device and be received by the system discussed herein for analysis. For example, the computing device system 400 may compile the log of program actions during operation and transmit said log via the network 150, shown in FIG. 1. Such a transmission may be in real-time (e.g., the computing device system 400 may transmit each program action individually) or periodic (e.g., the computing device system 400 may transmit the log, or parts of the updated log, via the network 150 at set intervals).

Referring now to Block 510 of FIG. 5, the method may include comparing the plurality of program actions with at least one known malicious event pattern of actions. The at least one malicious event pattern of actions includes a sequence of program actions present in a known malicious event. The at least one known malicious event pattern of actions may include details relating to previous malicious events. For example, the program actions of a known malicious event may include deleting volume shadows, file encryption discrepancies, unsigned executables, and/or the like.

The at least one known malicious event pattern of actions may be stored and/or compiled within a malicious event engine 360 (shown in FIG. 3). The malicious event engine 360 may be created and/or updated using machine learning. Machine learning can be used to determine known malicious event pattern of actions based on information received. For example, the malicious event engine 360 may receive a log with information relating to a known malicious event (e.g., either determined through the processes herein or otherwise) and then analyze said log in order to determine the given known malicious event pattern of actions. The known malicious event pattern of actions may be divided into subsets (e.g., the earlier program actions may be more relevant to catch a malicious event earlier). Additionally, the known malicious event pattern of actions can be compared to one another to determine a pattern across different malicious events. For example, a certain program action or sequence of program actions may occur in many malicious events and, as such, a sequence of program actions containing such a program action may be given more weight in a given comparison.

Referring now to Block 520 of FIG. 5, the method may include determining an occurrence of a potential malicious event based on the comparison of the plurality of program actions with at least one known malicious event pattern of actions.

The comparison of the plurality of program action with the at least one known malicious event pattern of actions may result in a confidence level or the like to indicate whether the plurality of program actions is indicative of a potential malicious event. The threshold for determining a potential malicious event may be based on the desired level of security. For example, a lower threshold confidence level to determine an occurrence of a potential malicious event would result in less malicious events being missed by the system, but would also likely increase the number of false positives (e.g., marking a given plurality of program actions as a potential malicious event when there is no malicious event taking place).

The determination of the occurrence of the potential malicious event can also include additional information relating to the potential malicious event. For example, the determination may also include the type of malicious event (e.g., ransomware) and/or the scope of the potential malicious event (e.g., how many files and/or devices are corrupted). Such information can be used by the system to determine the preventative response, as discussed in reference to Block 530 below.

In some embodiments, the method also includes determining the type of potential malicious event based on the comparison of the plurality of program actions with at least one known malicious event pattern of actions. In some cases, the plurality of program actions may match or closely resemble a known malicious event pattern of actions for a given type of malicious event. In some embodiments, the potential malicious event may have multiple potential event types (e.g., in an instance in which the plurality of program actions matches multiple different known malicious events).

Referring now to Block 530 of FIG. 5, the method may include determining a preventative response based on the potential malicious event. Such a preventative response may be carried out by the system (e.g., as shown in Block 540) and/or by a third party. For example, the system may notify another entity of the potential malicious event.

The preventative response may be a notification or action that mitigates and/or prevents the potential malicious event. The preventative response may be a notification (e.g., an alert that a potential malicious event is occurring). Additionally or alternatively, the preventative response may be an active action to stop the malicious event. Such an active action may be shutting down a network (e.g., to prevent the spread of a malicious event), locking out one or more users associated with the plurality of program actions, scrubbing files and/or programs relating to the plurality of program actions, and/or the like. The preventative response may be based on the type of potential malicious event and/or the scope of the potential malicious event. Additionally, the preventative response may be one or more operations to further analyze the program actions to verify the determination of a potential malicious event is correct.

In some embodiments, the preventative response may be the same for any potential malicious event. For example, the preventative response may be to send an error message or temporarily lock a user out of a device. In some instances, the preventative response may be different based on the potential malicious event itself. For example, the preventative response may be different based on the type of potential malicious event. Additionally, the preventative response may be based on the scope of the potential malicious event. For example, the preventative response may be different in an instance in which a potential malicious event is detected before it begins than an instance in which a potential malicious event has been occurring for a length of time.

Referring now to optional Block 540 of FIG. 5, the method may include causing an execution of the preventative response. In various embodiments, the preventative response may be carried out during the potential malicious event. As such, the preventative response may be an attempt to prevent a malicious event from occurring or to stop a malicious event in action (e.g., to mitigate an event in action). The preventative response may also contain multiple actions (e.g., a notification of potential malicious events could be transmitted in addition to locking out user(s) associated with the plurality of program actions).

Referring now to optional Block 550 of FIG. 5, the method may include updating a malicious event engine containing the at least one malicious event pattern of actions based on the potential malicious event.

In various embodiments, the malicious event engine is updated continuously or periodically. The malicious event engine can be updated based on third party information (e.g., just as the malicious event engine is created, the updating may be based on information relating to known malicious events). Additionally or alternatively, the malicious event engine can be updated based on the operations discussed herein. The determination of an occurrence of a potential malicious event, along with information relating to said potential malicious event (e.g., the plurality of program actions) may be provided to, and processed by, the malicious event engine. In some embodiments, the determination of an occurrence of a potential malicious event is transmitted to the malicious event engine upon determination that the given plurality of program actions likely indicates a potential malicious event (e.g., only information relating to potential malicious events is transmitted). Alternatively, all of the determinations of an occurrence of a potential malicious event are transmitted to the malicious event engine (e.g., the malicious event engine may also process non-malicious event information to improve the determination processes discussed herein).

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present disclosure may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the “C” programming language or similar programming languages.

Embodiments of the present disclosure are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the disclosure.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present disclosure are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for identifying a potential malicious event, the system comprising:
at least one non-transitory storage device; and
at least one processing device coupled to the at least one non-transitory storage device, wherein the at least one processing device is configured to:
receive a plurality of program actions comprising at least a first program action and a second program action, wherein the first program action is initiated before the second program action;
compare the plurality of program actions with at least one known malicious event pattern of actions, wherein the at least one malicious event pattern of actions comprises a sequence of program actions in a known malicious event;
based on the comparison of the plurality of program actions with at least one known malicious event pattern of actions, determine an occurrence of a potential malicious event; and
determine a preventative response based on the potential malicious event.

2. The system of claim 1, wherein the at least one processing device is further configured to cause an execution of the preventative response.

3. The system of claim 2, wherein the preventative response is carried out during the potential malicious event.

4. The system of claim 1, wherein the at least one processing device is further configured to update a malicious event engine using machine learning based on the determination of the potential malicious event.

5. The system of claim 1, wherein the preventative response is determined based on a type of potential malicious event determined.

6. The system of claim 1, wherein the preventative response comprises a notification of the potential malicious event.

7. The system of claim 1, wherein the preventative response comprises locking out a user associated with at least one of the plurality of program actions.

8. A computer program product for identifying a potential malicious event, the computer program product comprising at least one non-transitory computer-readable medium having computer-readable program code portions embodied therein, the computer-readable program code portions comprising:
an executable portion configured to receive a plurality of program actions comprising at least a first program action and a second program action, wherein the first program action is initiated before the second program action;
an executable portion configured to compare the plurality of program actions with at least one known malicious event pattern of actions, wherein the at least one malicious event pattern of actions comprises a sequence of program actions in a known malicious event;
an executable portion configured to determine an occurrence of a potential malicious event based on the comparison of the plurality of program actions with at least one known malicious event pattern of actions; and
an executable portion configured to determine a preventative response based on the potential malicious event.

9. The computer program product of claim 8, wherein the computer-readable program code portions further comprises an executable portion configured to cause an execution of the preventative response.

10. The computer program product of claim 9, wherein the preventative response is carried out during the potential malicious event.

11. The computer program product of claim 8, wherein the computer-readable program code portions further comprises an executable portion configured to update a malicious event engine using machine learning based on the determination of the potential malicious event.

12. The computer program product of claim 8, wherein the preventative response is determined based on a type of potential malicious event determined.

13. The computer program product of claim 8, wherein the preventative response comprises a notification of the potential malicious event.

14. The computer program product of claim 8, wherein the preventative response comprises locking out a user associated with at least one of the plurality of program actions.

15. A computer-implemented method for identifying a potential malicious event, the method comprising:
receiving a plurality of program actions comprising at least a first program action and a second program action, wherein the first program action is initiated before the second program action;
comparing the plurality of program actions with at least one known malicious event pattern of actions, wherein the at least one malicious event pattern of actions comprises a sequence of program actions in a known malicious event;
based on the comparison of the plurality of program actions with at least one known malicious event pattern of actions, determining an occurrence of a potential malicious event; and
determining a preventative response based on the potential malicious event.

16. The method of claim 15, further comprising causing an execution of the preventative response.

17. The method of claim 16, wherein the preventative response is carried out during the potential malicious event.

18. The method of claim 15, further comprising updating a malicious event engine using machine learning based on the determination of the potential malicious event.

19. The method of claim 15, wherein the preventative response is determined based on a type of potential malicious event determined.

20. The method of claim 15, wherein the preventative response comprises locking out a user associated with at least one of the plurality of program actions.
